(19) United States
(12) Patent Application Publication
(10) Pub. No.: US 2011/0174103 A1
(43) Pub. Date: Jul. 21, 2011

(54) DOUBLE CLUTCH FOR CARS

(75) Inventors: Eckhard Kirchner, Ginsheim (DE); Mikael Westerberg, Vaenersborg (SE)

(73) Assignee: GM GLOBAL TECHNOLOGY OPERATIONS LLC, Detroit, MI (US)

(21) Appl. No.: 13/009,392

(22) Filed: Jan. 19, 2011

(30) Foreign Application Priority Data
Jan. 19, 2010 (GB) 1000793.8

(51) Int. Cl. F16H 3/08; F16D 21/00; F16D 13/22

(52) U.S. Cl. 74/325; 192/48.1

(57) ABSTRACT

There is provided a double clutch for connecting a crankshaft of an engine to one of two input shafts of a gearbox for engine torque transmission. The double clutch includes, but is not limited to a first clutch for selectively connecting a first input shaft of the gearbox to the crankshaft, a second clutch for selectively connecting a second input shaft of the gearbox to the crankshaft, and an actuator coupled to both the first clutch and the second clutch. The actuator is operable to move the first clutch and the second clutch between a default position and an activated position. In the default position, the first clutch connects the first input shaft to the crankshaft while the second clutch disconnects the second input shaft from the crankshaft. In the activated position, the first clutch disconnects the first input shaft from the crankshaft while the second clutch connects the second input shaft to the crankshaft. The crankshaft is always connected to one of the input shafts.

### CROSS-REFERENCE TO RELATED APPLICATION

This application claims priority to British Patent Application No. 1000793.8, filed Jan. 19, 2010, which is incorporated herein by reference in its entirety.

### TECHNICAL FIELD

The technical field relates to a double clutch for cars.

### BACKGROUND

A car with the double clutch can have both comfort of a stepped automatic transmission and high basic efficiency of a manual transmission. However, the double clutch is typically complex and expensive to build. Known dual clutch systems are bulky and difficult to fit into packaging space of existing car models with a single clutch transmission.

### SUMMARY

According to the application, there is provided a double clutch for connecting a crankshaft of an engine to one two input shafts of a gearbox for engine torque transmission. The double clutch comprises a first clutch for selectively connecting a first input shaft of the gearbox to the crankshaft and a second clutch for selectively connecting a second input shaft of the gearbox to the crankshaft. The double clutch also comprises an actuator that is coupled to both the first clutch and the second clutch. The actuator is operable to move the first clutch and the second clutch between a default position and an activated position. In the default position, the first clutch connects the first input shaft to the crankshaft whilst the second clutch disconnects the second input shaft from the crankshaft.

In the activated position, the first clutch disconnects the first input shaft from the crankshaft whilst the second clutch connects the second input shaft to the crankshaft. The crankshaft is always connected to one of the input shafts.

The term “always” refers to all gearshift positions, including neutral gearshift position even when the engine is running or not. The crankshaft is connected to one input shaft regardless whether the engine is running or not. However, the driving torque at the input of the gearbox is not transmitted to the output of the gearbox for the neutral gearshift position even when the engine is running. The term “connected” refers to frictional contact. Every gearshift position, including neutral gearshift position, corresponds to either the activated position or to the default position. Even when the engine is not running, the crankshaft is connected to one input shaft. There could be a period only during gear change when two clutches are engaged or are disengaged with both input shafts.

The double clutch is configured for alternating the double clutch between the default position and the activated position such that connection of the crankshaft to one of the two input shafts and disconnection of the crankshaft to the other input shaft are performed simultaneously.

The double clutch arrangement described here has reduced system complexity and part content from two actuators to one for triggering engagement of any of the two clutches. The reduction brings substantial cost reduction, especially in mass production of cars. The reduction further makes the double clutch to be compact. Additionally, since there is only a single activation movement required in the double clutch, the actuator can be made simple. A simple and reliable cylinder at low cost can be implemented for the actuator. The cylinder includes mechanical, hydraulic or pneumatic drive units with a single thrust direction.

Since one of the two clutches is naturally closed, the double clutch prevents hard contacts between a pressure plate and a friction plate when using a worn clutch. Any of the naturally open and the naturally closed clutch is possible to be used for coupling to a driving gear. If a naturally open clutch is connected to the driving gear, it helps to reduce actuator loss during a neutral idle portion of a driving cycle because friction plates of the naturally open clutch is not subjected to wear in the neutral idle mode. The double clutch helps to improve fuel efficiency in a vehicle because there is little loss of driving torque during transitions between the two clutches.

If the normally open clutch is connected to a first gear as a launch gear, it can reduce the risk of idle clatter when having the neutral gear selected. At this moment, no even gear is engaged to the crankshaft. Even when the launch gear is coupled to the crankshaft, the launch gear mounted input shaft is not forced to rotate because a synchronizer of the launch gear can be detached its associated input shaft. No gear needs to follow the crankshaft to revolve unintentionally before launching so that noise of the double clutch is reduced. The first gear is also known as a first gear speed.

The double clutch also provides benefits of reducing a park lock of the vehicle because the double clutch can engage one gearwheel of a gearbox with the naturally closed clutch in the default position. The gearwheel is locked by a pinion on the same layshaft, which in turn locks the double clutch at the default position. Hence, the double clutch can substantially reduce or eliminate the need of having of a park actuation cable for extra cost and weight reduction.

The actuator of the double clutch can be purely electrically operated for optimum comfort and fast response when shifting and engaging a park of the vehicle. A driver interface of the electrically operated actuator can be flexibly located within a cabin for further design freedom of the vehicle, such as improving style and ergonomics for the driver.

The first input can comprise am inner input shaft, whilst the second input shaft can comprise an outer input shaft. The outer input shaft encloses a part of the inner input shaft. Accordingly, the first clutch that is provided for connecting the inner input shaft to the crankshaft can also be known as an inner clutch. The second clutch that is provided for connecting the outer input shaft to the crankshaft may further be known as an outer clutch. Hence, the double clutch can comprise the inner clutch and the outer clutch.

The inner clutch can be disengaged from the crankshaft and the outer clutch is engaged to the crankshaft in the default position. The double clutch assumes the default position without external power supply, such as by spring forces of two clutch levers of the two clutches respectively. The default position can also be kept when a vehicle with the double clutch is in operation. The default position can alternatively set by changing the inner clutch to be engaged and the outer clutch to be disengaged. The vehicle resumes the default position when parking. The default position provides convenience in fast start-up of a launching gear, wherein the launching gear is coupled to the crankshaft in the default position.

The double clutch can also provide an activated position that the inner clutch is engaged to the crankshaft and the outer clutch is disengaged from the crankshaft. The activated position provides an opposite situation of the default position. Usually, in the default position, the double clutch is connected one gearwheel group, whilst the double clutch is connected to another gearwheel group in the activated position. One advantageous implementation is to connected gearwheels of odd gears to the double clutch at the default position and to connect gearwheels of even gears at the activated position. Such arrangement enables quick launching of the vehicle with the double clutch.

The double clutch can comprise a dual mass flywheel for connecting to the crankshaft. The dual mass flywheel dampens vibration between the double clutch and the crankshaft during torque transmission.

The double clutch can further comprise a dry double clutch that has a center plate between an inner friction plate of an inner dry clutch and an outer friction plate of an outer dry clutch. The inner dry clutch is a form of the inner clutch whilst the outer dry clutch is a form of the outer clutch. Both the inner friction plate and the outer friction plate share the center plate such that the double clutch can be reduced in weight and cost by avoiding two plates for the two friction plates separately. The center plate further aids shortening a length of the double clutch in its longitudinal axis because only one center plate is required to cooperate with the two friction plates.

Alternatively, the dry inner clutch and dry outer clutch can have an axial arrangement that the two friction plates have a similar distance from the two input shafts. The axial arrangement enables the dry double clutch to be compact in a radial direction of the dry double clutch. The radial direction points to an area around the longitudinal axis of the dry double clutch.

The inner clutch can comprise an inner splined hub on the inner input shaft for engaging the inner input shaft and the outer clutch can comprise an outer splined hub on the outer input shaft for engaging the outer input shaft. The splined hubs that mesh with the two input shafts provide efficient torque transmission. The splined hubs can also easily be installed to or disassembled from the two input shafts. The double clutch can further comprise an inner clutch lever for actuating the inner clutch and an outer clutch lever for actuating the outer clutch. Both the inner clutch lever and the outer clutch lever are mounted on a same side of the two splined hubs in the longitudinal axis direction. Any of the inner clutch lever and the outer clutch lever can be in a disc form, which is alternatively termed as a diaphragm or a plate spring. These two levers are spring steels with resilience in the direction of the longitudinal axis such that they can push any of the pressure plates to the default position. In other words, these two levers can cause the double clutch back to the default position in the absence of external power supply, merely by using spring forces of the two levers, which can be diaphragm spring in most cases.

Since the two splined hubs are located on one side and the two clutch levers are on the other side following the longitudinal axis, there is no clutch lever positioned between the two splined hubs. This arrangement enables the double clutch to be compact in the direction of the longitudinal axis. Operations of the two clutch levers also become more reliable and the two clutches are easy to maintain in this manner.

The actuator can comprise an inner branch for actuating the inner clutch lever via an inner clutch bearing at its end and an outer branch for actuating the outer clutch lever at its end via an outer clutch bearing. The same actuator has two extended arms that trigger the two clutch levers. No two independently operated actuators are needed for operating the two clutches of the double clutch, which brings cost saving and weight reduction to the double clutch.

The double clutch can be a wet double clutch that comprises a wet inner clutch and a wet outer clutch. Parts of the wet inner clutch and the wet outer clutch are immersed in a cooling lubricating fluid that ensures smoother performance and longer life of the wet double clutch. Each of the two wet clutches has stacked multiple clutch disks for compensating lower coefficient of these clutch disks.

These two wet clutches can further be radially disposed around a longitudinal axis of the double clutch such that a distance of the wet double clutch in the longitudinal axis direction is less than that of the two wet clutches positioned in the longitudinal axis direction. Alternatively, the two wet clutches may be arranged axially along the longitudinal axis of the wet double clutch. In other words, the wet inner clutch and the wet outer clutch have a substantially similar distance from the longitudinal axis of the wet double clutch such that the wet double clutch becomes more compact in its radial direction.

The wet double clutch can comprise a cooling pump that circulates one or more coolants around the wet double clutch. The cooling pump moves the coolants to a heat sink for keeping the wet double clutch below a predetermined temperature when in continuous operation.

The wet double clutch can comprise an inner splined hub on the inner input shaft for engaging the inner input shaft and an outer splined hub on the outer input shaft for engaging the outer input shaft. The inner splined hub and the outer splined hub are closely neighboring to each other so that the wet double clutch can be short in the longitudinal axis direction.

The double clutch can further comprise a restoring mechanism for re-establishing the double clutch from the activated position back to the default position in the absence of external power supply. The restoring mechanism can be realized by two resilient clutch levers on the input shafts, which push the two clutches to the default position. The restoring mechanism can further be realized either by an elastic spring member or by two hydraulic cylinders connected to a pressure reservoir for moving the two clutches to the default position. Pneumatic, electromagnetic or a combination of any these can be employed to provide the restoring mechanism.

The present application further provides a double clutch transmission that comprises a double clutch and a gearbox connected to the double clutch. The gearbox comprises a first input shaft and a second input shaft for selectively connecting to the double clutch. The gearbox also comprises a layshaft and gearwheels that are mounted on the input shafts and the layshaft.

The gearwheels comprises one or more fixed gearwheel on the input shafts and one or more idler gearwheels on the layshaft meshing with the at least one fixed gearwheel. One or more coupling device is mounted on the layshaft for connecting the one or more idler gearwheel to the layshaft. The gearbox also comprises a pinion that is mounted on the layshaft. The double clutch transmission avoids using two actuators for engaging and disengaging the two clutches. Hence, the double clutch is compact and light at low cost. The double clutch transmission is also simple to design and manufacture.

The double clutch transmission further comprises gearwheels of different driving gears for providing various output speeds of the double clutch transmission. The double clutch transmission enables driving at different speeds for better fuel efficiency. The double clutch transmission can provide pre-selection of gear speeds when the vehicle changes its driving speed. An on-board engine control unit can cause a coupling device to engage an idler gearwheel of a next driving speed automatically, which is known as pre-selection. The pre-selection is also possible for gear speed skip-shifts from even to odd gears, or from odd to even gears. The pre-selection enables smooth transition of torque flow between different gear speeds. The vehicle is thus made more fuel-efficient by having the pre-selection function.

The present application also provides a power train that comprises an engine for generating a driving torque, a double clutch transmission that is connected between the engine for receiving the driving torque, and differentials for transmitting the received driving torque to a final drive. In a car, the final drive can be wheels. A vehicle according to present application comprises the final drive and the powertrain for driving the final drive.

The present application provides a method for using a double clutch for every gearshift positions. The every gearshift position can be a neutral gearshift position. The method comprises a step of connecting a crankshaft to the gearbox via a first clutch whilst a second clutch is disconnected from the gearbox and a step of connecting the crankshaft to the gearbox via the second clutch whilst the first clutch is disconnected from the gearbox. The method can be used for shifting between a neutral gearshift position and another gearshift position. In the neutral gearshift position, a torque of the engine is not transmitted to the final drive.

### BRIEF DESCRIPTION OF THE DRAWINGS

The present invention will hereinafter be described in conjunction with the following drawing figures, wherein like numerals denote like elements, and.

FIG. 1 illustrates a schematic diagram of a double clutch;

FIG. 2 illustrates structures of a dry double clutch according to the schematic diagram of FIG. 1;

FIG. 3 illustrates a cross sectional view of the dry double clutch that is in a default position;

FIG. 4 illustrates a cross sectional view of the dry double clutch that is in an activated position;

FIG. 5 illustrates a double clutch transmission that comprises the dry double clutch of FIG. 2;

FIG. 6 illustrates a coupling device of the double clutch transmission; and

FIG. 7 illustrates a wet double clutch according to the schematic diagram of FIG. 1.

### DETAILED DESCRIPTION

The following detailed description is merely exemplary in nature and is not intended to limit application and uses. Furthermore, there is no intention to be bound by any theory presented in the preceding background or summary or the following detailed description. In the following description, details are provided to describe one or more embodiments of the application. It shall be apparent to one skilled in the art, however, that these embodiments may be practiced without such details.

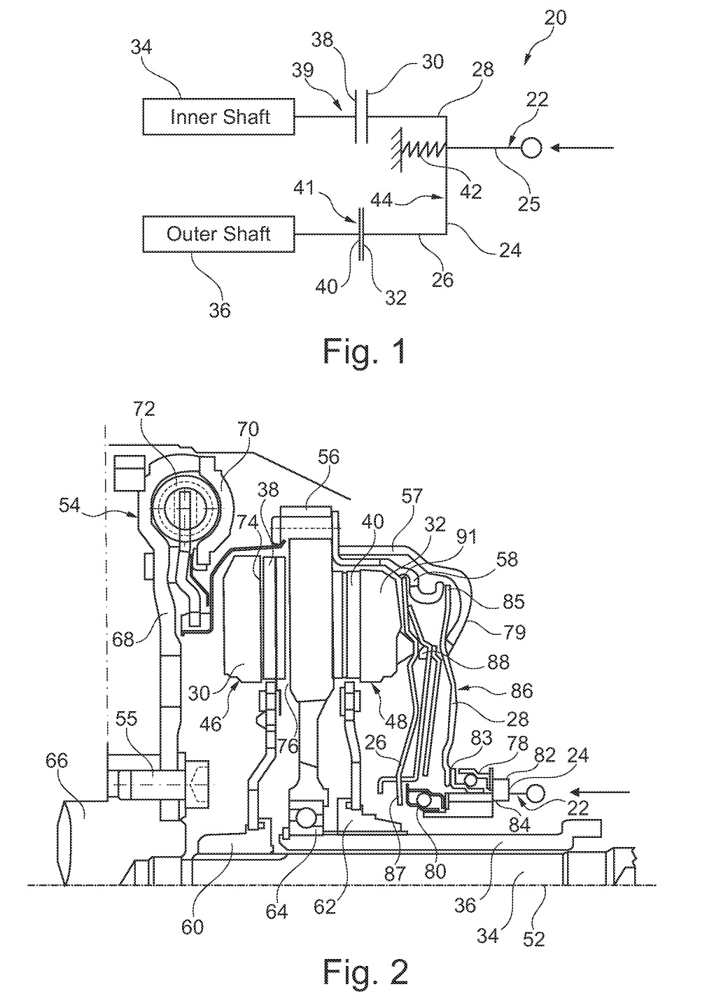

FIG. 1 to FIG. 6 facilitates the detailed description of a first embodiment of a double clutch of the present application. As previously indicated, FIG. 1 to FIG. 6 comprises similar parts that have same reference numbers, and relevant description of these parts is incorporated where appropriate.

FIG. 1 illustrates a schematic diagram of a double clutch 20. The double clutch 20 comprises an actuator 22 that is connected to an inner clutch 39 and to an outer clutch 41. The inner clutch 39 is further connected to an inner input shaft 34 whilst the outer clutch 41 is further connected to an outer input shaft 36. The inner input shaft 34 is also known as an inner shaft. Similarly, the outer input shaft 36 is also known as an outer shaft. In practice, the outer input shaft 36 encloses the inner input shaft 34 coaxially, although the inner input shaft 34 and the outer input shaft 36 are drawn separately in FIG. 1.

The actuator 22 comprises a cross bar 24 and an actuator bar 25 that are joined together. The joint is provided such that the cross bar 24 is perpendicular to the actuator bar 25. The actuator bar 25 is positioned on one side of the cross bar 24 whilst a pivot 44 and a biasing spring 42 of the actuator 22 are located on an opposite side of the cross bar 24. The cross bar 24 is supported by the biasing spring 42 and the cross bar 24 can tilt around the pivot 44.

The inner clutch 39 comprises an inner friction plate 38 and an inner pressure plate 30. The inner friction plate 38 is arranged parallel to the inner pressure plate 30. The inner clutch 39 is connected to the inner input shaft 34 and the inner pressure plate 30 is connected to an inner clutch lever 28. The inner clutch lever 28 is further connected to an end of the cross bar 24.

Similarly, the outer clutch 41 comprises an outer friction plate 40 and an outer pressure plate 32, which is arranged parallel to the outer friction plate 40. The outer friction plate 40 is connected to the outer input shaft 36 and the outer pressure plate 32 is connected to the outer clutch lever 26. The outer clutch lever 26 is further connected to another end of the cross bar 24. The two clutch levers 26, 28 are also known as diaphragms or plate springs.

The double clutch 20 has a default position and an activated position. The double clutch 20 can transit between these two positions. Only one of the two clutches 39, 41 of the double clutch 20 is always engaged, while the other clutch 39, 41 is disengaged. The engagement allows transmission of engine torque.

In the default position, which is shown in FIG. 1, no external activation force is applied to the actuator bar 25. The biasing spring 42 and the pivot 44 cooperate to disengage the inner clutch 39 and to engage the outer clutch 41. When the inner clutch 39 is disengaged, the inner pressure plate 30 is detached from the inner friction plate 38 and no friction contact is established between the inner friction plate 38 and the inner pressure plate 30. When the outer clutch 41 is engaged, the outer pressure plate 32 is attached to the outer friction plate 40 and friction contact is established between the outer pressure plate 32 and the outer friction plate 40.

In the activated position, which is shown in FIG. 4, the actuator bar 25 receives the external activation force. The external activation force pushes the actuator bar 25 forward such that the biasing spring 42 and the pivot 44 cooperate to engage the inner clutch 39 and to disengage the outer clutch 41. When the inner clutch 39 is engaged, the inner pressure plate 30 is attached to the inner friction plate 38 and friction contact is established between the inner pressure plate 30 and the inner friction plate 38. When the outer clutch 41 is disengaged, the outer pressure plate 32 is detached from the outer friction plate 40 and no friction contact is established between the outer pressure plate 32 and the outer friction plate 40.

FIG. 2 illustrates structures of an upper half of a dry double clutch 50 according to the schematic diagram of FIG. 1. The dry double clutch 50 includes components of the double clutch 20 of FIG. 1. The dry double clutch 50 is symmetrical about its a longitudinal axis 52.

FIG. 2 shows the dry double clutch 50 that is connected between a flywheel 54 and two coaxial input shafts 34, 36. The flywheel 54 is a dual mass flywheel that comprises a primary flywheel 70 and a secondary flywheel 68. The secondary flywheel 68 is mounted on a crankshaft 66 of an engine for outputting driving torque of the engine to the dry double clutch 50. The flywheel 54 is fixed to the crankshaft 66 via bolts 55. The two input shafts 34, 36 are inserted into a cavity of the dry double clutch 50 such that one of the two input shafts 34, 36 can receive the driving torque from the crankshaft 66 via the dry double clutch 50. The dry double clutch 50 comprises a dry inner clutch 46, a dry outer clutch 48, an actuator 22, a center plate 56 and some other components.

The actuator 22 is connected to both of the two clutches 46, 48. A circumferential edge of the center plate 56 is joined to the flywheel 54 whilst a center portion of the center plate 56 is supported by a ball bearing 64 that is placed on the outer input shaft 36. These parts are adapted such that the center plate 56 is rotatable about the outer input shaft 36. The dry inner clutch 46 is located on the left of the center plate 56 and the dry outer clutch is located on the right of the center plate 46.

The dry inner clutch 46 comprises an inner friction plate 38 for attaching frictionally to an inner pressure plate 30. The inner pressure plate 30 is connected to the actuator 22 via an elongated lever arm 57 and an inner clutch lever 28. The inner friction plate 38 is supported by an inner splined hub 60 that is placed on the protruding end of the inner input shaft 34. The inner pressure plate 30 is positioned next to a first side of the center plate 56. The inner input shaft 34 and the inner splined hub 60 are arranged such that the inner splined hub 60 is mounted onto the inner input shaft 34 and the inner splined hub 60 meshes with the inner input shaft 34. The inner splined hub 60 has an array of grooves that meshes with a series of spaced ridges on the inner input shaft 34 such that the inner splined hub 60 can have axial movement on the inner input shaft 34.

The dry outer clutch 48 comprises an outer friction plate 40 for attaching frictionally to an outer pressure plate 32. The outer pressure plate 32 is connected to the actuator 22 via the outer clutch lever 26. The outer friction plate 40 is supported by an outer splined hub 62 that is placed on the outer input shaft 36. The outer friction plate 40 is positioned next to a second side of the center plate 56. The second side is opposite to the first side. The outer input shaft 36 and the outer splined hub 62 are arranged such that the outer splined hub 62 is mounted onto the outer input shaft 36 and the outer splined hub 62 meshes with the inner input shaft 34. The inner splined hub 60 has an array of grooves that meshes with a series of spaced ridges on the inner input shaft 34 such that the outer splined hub 62 can move axially on the outer input shaft 36.

The actuator 22 comprises an inner arm and an outer arm to activate any of the two clutches 46, 48 at a time. By default, the dry outer clutch 48 is activated and the dry inner clutch 46 is deactivated. When the actuator 22 moves to another position, the dry outer clutch 48 is deactivated and the dry inner clutch 46 becomes activated.

The inner arm includes an inner branch 82, an inner clutch bearing 78, an inner clutch lever 28, an inner clutch clip, the elongated lever arm 57 that are sequentially joined together. The inner branch 82 is connected to the inner clutch bearing 78, which is also connected to the inner clutch lever 28 at its inner clutch lever central end 83. A remote end 85 of the inner clutch lever 28 held between the elongated lever arm 57 and the clutch cover 58. An inner clutch clip 79 is attached between a middle portion of the inner clutch lever 28 and an end of the elongated lever arm 57 for joining them together. In an alternative, the inner clutch clip 79 can be replaced by a rivet that connects the end of the elongated lever arm 57 and the inner clutch lever 28 together.

On one hand, by default, natural spring force of the inner clutch clip 79 causes the inner clutch lever 28 to tilt for biasing the elongated lever arm 57. The inner clutch lever 28 is further connected to the inner pressure plate 30 and the natural spring force detaches the inner pressure plate 30 away from the inner friction plate 38 for opening the dry inner clutch 46. On the other hand, as the actuator 22 moves to the activated position, the inner clutch lever 28 rotates around its middle portion and the remote end 85 causes the elongated lever arm 57 to shift. The advancement of the elongated lever arm 57 brings the inner pressure plate 30 onto the inner friction plate 38, thus engages the dry inner clutch 48. The inner clutch bearing 78 maintains contacts with both the inner clutch lever 28 and with the inner branch 82 when the inner clutch lever 28 rotates around the longitudinal axis 52.

The outer arm comprises an outer branch 84, an outer clutch bearing 80 and an outer clutch lever 26. The outer branch 84 is connected to the outer clutch bearing 80, which is also connected to the outer clutch lever 26 at its outer clutch lever central end 87. A remote end 91 of the outer clutch lever 26 is held with the clutch cover 58 as a pivotal joint. A middle portion of the outer clutch lever 26 is joined to the outer pressure plate 32 via a ball joint 88. The outer clutch lever 26 can tilts around the remote end 91 for bring the outer pressure plate 32 onto or away from outer friction plate 40. Natural spring force of the outer clutch lever 26 biases the outer pressure plate 32 onto the outer friction plate 40 for engaging the dry outer clutch 48. The outer clutch bearing 80 maintains contacts with both the outer clutch lever 26 and with the outer branch 84 when the outer clutch lever 26 rotates around the longitudinal axis 52.

The crankshaft 66 translates reciprocating linear motion of pistons of an engine into rotational motion of the crankshaft 66. The rotational motion transmits a driving torque from the pistons to the flywheel 54. The flywheel 54 has a significant moment of inertia for storing rotational energy that is converted from the driving torque. The moment of inertia also absorbs fluctuations of the driving torque. The center plate 56 receives the driving torque from the flywheel 54 via their connection.

The dry double clutch 50 acts to transmit the driving torque from the crankshaft 66 to either the inner input shaft 34 or the outer input shaft 36. The dry double clutch 50 interchanges between a default position and an activated position. The dry double clutch transmits the driving torque from the flywheel 54 to one of the input shafts 34, 36 at any of these two positions. In the default position, the dry inner clutch 46 is engaged and the dry outer clutch 48 is disengaged. In the activated position, the dry inner clutch 46 is disengaged and the dry outer clutch 48 is engaged.

When the dry inner clutch 46 is disengaged, which is shown in FIG. 2, a left inner gap 74 of roughly 0.75 mm exists between the inner pressure plate 30 and the inner friction plate 38. In the mean time, a right inner gap 76 of the same magnitude exists between the center plate 56 and the inner friction plate 38. The gaps 74, 76 exist such that there is no friction contact between the inner friction plate 38 and the center plate 56. When the dry inner clutch 46 is engaged, the inner pressure plate 30, the inner friction plat 38 and the center plate 56 are clamped together with no gap in-between all of them.

Similarly, when the dry outer clutch 48 is disengaged, a left outer gap of roughly 0.75 mm exists between the outer pressure plate 32 and the outer friction plate 40. In the mean time, a right outer gap of the same magnitude exists between the center plate 56 and the outer friction plate 40. The gaps exist such that there is no friction contact between the outer friction plate 40 and the center plate 56. When the dry outer clutch 46 is engaged, the outer pressure plate 32, the outer friction plat 40 and the center plate 56 are clamped together with no gap in-between all of them.

In particular, the dry inner clutch 46 acts to receive the driving torque from the flywheel 54 when it is engaged. In the engaged state, the inner pressure plate 30 forces the inner friction plate 38 onto the center plate 56 for providing friction contact between the inner friction plate 38 and the center plate 56. The inner friction plate 38 is used for receiving the driving torque from the center plate 56 when the friction contact is established. The inner friction plate 38 is also intended for transmitting the driving torque to the inner input shaft 34 via the meshing between the inner splined hub 60 and the inner input shaft 34. The inner input shaft 34 is used for delivering the driving torque to wheels of a vehicle. The driving torque of the inner input shaft 34 is delivered to fixed gearwheels that are mounted on the inner input shaft 34 and further to idler gearwheels that comb with the fixed gearwheels.

The actuator acts for providing an external activation force to engage the dry inner clutch 46. The inner clutch bearing 78 is used for conveying the external activation force to the inner clutch lever 28. The inner clutch lever 28 is provided for receiving the external activation force from the inner clutch bearing 78 and for applying the force onto the inner pressure plate 30. The pivot 44 is intended for tilting the inner clutch lever 28 when the inner clutch lever 28 is moved by the inner clutch bearing 78. The inner pressure plate 30 is used for moving the inner friction plate 38 onto the center plate 56 for providing the friction contact.

Similarly, the dry outer clutch 48 acts to receive the driving torque from the flywheel 54 when it is engaged. In the engaged state, the outer pressure plate 32 forces the outer friction plate 40 onto the center plate 56 for providing friction contact between the outer friction plate 40 and the center plate 56. The outer friction plate 40 is used for receiving the driving torque from the center plate 56 when the friction contact is established. The outer friction plate 40 is also intended for transmitting the driving torque to the outer input shaft 36 via the meshing between the outer splined hub 62 and the outer input shaft 36. The outer input shaft 36 is used for delivering the driving torque to the wheels of the vehicle. The driving torque of the outer input shaft 36 is delivered to fixed gearwheels that are mounted on the outer input shaft 36 and further to idler gearwheels that comb with the fixed gearwheels.

The actuator also acts for providing an external activation force to engage the dry outer clutch 48. The outer clutch bearing 80 is used for conveying the external activation force to the outer clutch lever 26. The out clutch lever 26 is provided for receiving the external activation force from the outer clutch bearing 80 and for applying the force onto the outer pressure plate 32. The outer pressure plate 32 is used for moving the outer friction plate 40 onto the center plate 56 for providing the friction contact.

A method of using the dry double clutch 50 is described below. The engine is firstly started while the vehicle is still in a standstill position. The actuator 22 does not exert the external activation force. Hence, the dry double clutch 50 is in the default position. The driving torque is then transmitted from the crankshaft 66, via the flywheel 54, via the center plate 56, via the dry outer clutch 48, to the outer input shaft 36. Later the actuator 22 exerts the external activation force. The dry double clutch afterward shifts to the activated position. The driving torque is then transmitted from the crankshaft 66, via the flywheel 54, via the center plate 56, via the dry inner clutch 48, to the inner input shaft 34. By alternating between the activated position and the default position, the driving torque is transmitted to either the outer input shaft 36 or to the inner input shaft 34.

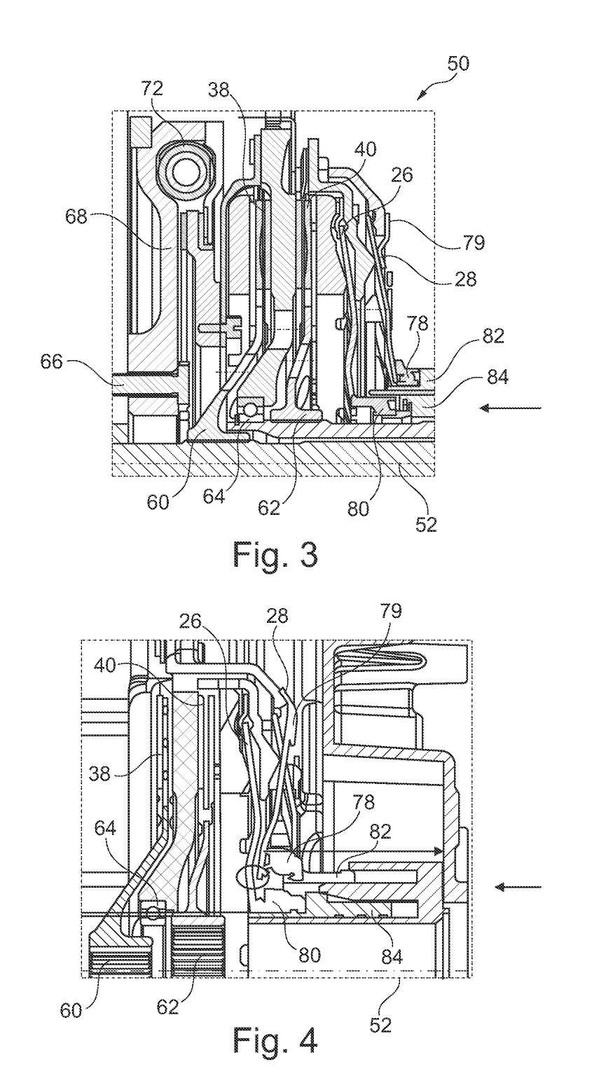

FIG. 3 illustrates a cross sectional view of the dry double clutch 50 that is in the default position. FIG. 4 illustrates a cross sectional view of the dry double clutch 50 that is in an activated position. No interference is found between two clutch levers 26, 28 in any of these two positions.

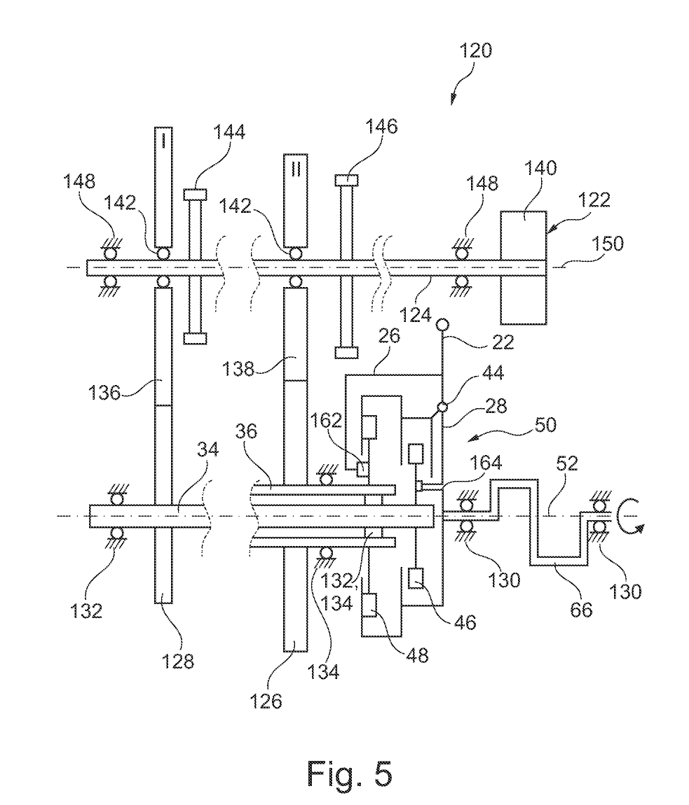

FIG. 5 illustrates a double clutch transmission 120. The double clutch transmission 120 comprises a gearbox 122 and the dry double clutch 50 of FIGS. 1-4. The dry double clutch 50 is connected between the crankshaft 66 of FIGS. 1-4 and the gearbox 122. The crankshaft 66 is supported on crankshaft bearings 130 at its two opposite ends.

The gearbox 122 comprises the two input shafts 34, 36 of FIG. 1 and a layshaft 124. The layshaft 124 is positioned parallel to the input shafts 34, 36. The layshaft 124 has a longitudinal axis 150 as its axis of rotation.

The inner input shaft 34 is inserted into the outer input shaft 36 in forming an input shaft assembly. Input shaft bearings are installed between the two input shafts 34, 36 for joining them together. The input shaft assembly has a first end and a second end. The inner input shaft 34 protrudes from the outer input shaft 36 at the first end. The second end of the input shaft assembly is inserted into and is connected to the dry double clutch 50. A first fixed gearwheel 128 is fixed onto the protruding portion of the inner input shaft 34. A second fixed gearwheel 126 is fixed onto the outer input shaft 36.

The layshaft 124 is supported on bearings 148. A first idler gearwheel 136, a second idler gearwheel 138, the two coupling devices 144, 146 and a pinion 140 are provided on the layshaft 124. In particular, the first idler gearwheel 136 and the second idler gearwheel 138 are mounted onto the layshaft 124 via bearings 142. A first coupling device 144 is mounted next to the first idler gearwheel 136. A second coupling device 146 is mounted next to the second idler gearwheel 138. The pinion 140 is fixed at an end of the layshaft 124 that neighbors the second coupling device 146. The first idler gearwheel 136 meshes with the first fixed gearwheel 128 and the second idler gearwheel 138 meshes with the second fixed gearwheel 126.

The first coupling device 144 provides synchronization and locking functions for engaging the first idler gearwheel 136 to the layshaft 124. The first coupling device 144 is able to bring the first idler gearwheel 136 and the layshaft 124 from different rotation speeds to a same rotation speed by the synchronization. The first coupling device 144 is also able to lock the first idler gearwheel 136 and the layshaft 124 together for transmitting the driving torque. Similarly, the second coupling device 146 provides synchronization and locking functions for engaging the second idler gearwheel 138 to the layshaft 124.

The first coupling device 144 and the second coupling device 146 have similar structures and parts. Description of the second coupling device 146 is thus applicable to the first coupling device 144 where applicable.

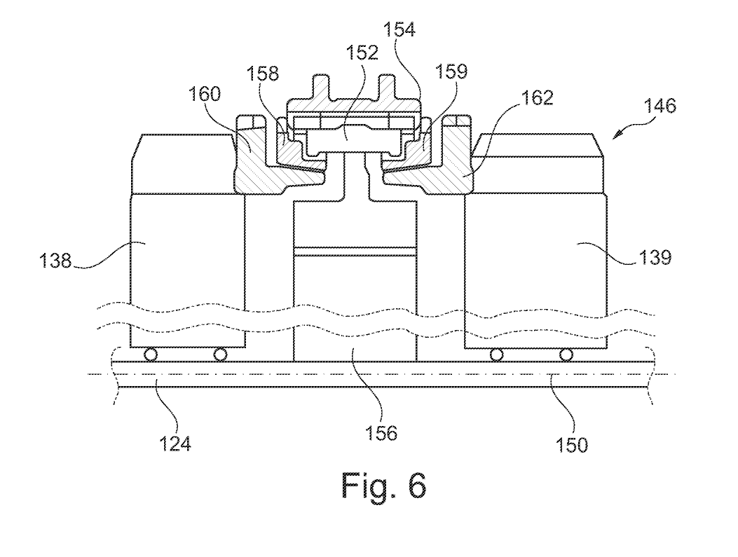

FIG. 6 illustrates the second coupling device 146 of the double clutch transmission 120 in further details. The second coupling device 146 is positioned on the layshaft 124 between the second idler gearwheel 138 and another idler gearwheel 139. The second coupling device 146 comprises a synchronizer hub 156 and a sleeve 154. The synchronizer hub 156 is fixed to the layshaft 124. The sleeve 154 engages with the synchronizer hub 156 by splines such that the sleeve 154 and the synchronizer hub 156 can rotate together about the layshaft 124 at the same speed. The splines refer to uniformly spaced ridges on the layshaft 124 that fit into corresponding slots on the sleeve 18. The splines are not shown in the FIG. 6. In addition, the sleeve 154 is axially movable on an outer surface of the synchronizer hub 156. Moreover, the second coupling device 146 includes a first block ring 158, a second block ring 159, and an insert key 152. The insert key 152 abuts the sleeve 154 such that the sleeve 154 can move the insert key 152 in both axial directions of the sleeve 154. The second coupling device 146 also comprises a first dog ring 160 between the second idler gearwheel 138 and the first block ring 158. The first dog ring 160 is fixed to the second idler gearwheel 138 at a side. Similarly, the second coupling device 146 comprises a second dog ring 162 between the other idler gearwheel 139 and the second block ring 159. The second dog ring 162 is fixed to the other idler gearwheel 139 at a side.

In one axial direction, the insert key 152 pushes against the first block ring 158 whilst in the other axial direction, the insert key 152 pushes against the second block ring 159. A first inner peripheral surface of the first block ring 158 is tapered to engage frictionally against a first cone portion of a first dog ring 160. The first cone portion is also called a synchronizer cup. Similarly, a second inner peripheral surface of the second block ring 21 is also tapered to engage frictionally against a second cone portion of a second dog ring 162.

The synchronizer hub 156 and the sleeve 154 are mainly made of steel, but the first and the second block rings 158 and 159 are made of brass, which is softer than the steel material for reducing wear loss of the first and the second cone portions.

The dog rings 160 and 162 include a number of teeth that are evenly distributed around peripherals of the dong rings 160 and 162. The dog rings 160 and 162 are moveable along the axis of the layshaft 124 for selectively locking any of the idler gearwheels 138 and 139 with the layshaft 124.

In a generic sense, the double clutch transmission 120 includes more gearwheels with corresponding coupling devices. The coupling devices can be of double-acting type that is described above for engaging two gearwheels or it can be of a single-acting type, which is designed for engaging only one gearwheel.

Functionally, the first block ring 158 and the first cone portion act as friction members of a first friction clutch for synchronizing the rotational of the second idler gearwheel 138 and the layshaft 124. Likewise, the second block ring 159 and the second cone portion act as friction members of a second friction clutch for synchronizing the idler gearwheel 139 and the layshaft 124.

A method of using the second coupling device 146 comprises a step of moving a shift fork to shift the sleeve 18 in a predetermined axial direction. In one axial direction, the insert key 152 abuts the insert key 152 to push the block rings 158 or 159 towards the corresponding gearwheel 138 or 139. The shift lever is not shown in the FIG. 6. The inner tapered peripheral surface of the block ring 158 or 159 then engages forcedly against the respective cone portions of the gearwheel 138 or 139 as its mating member. This generates a frictional force to synchronize the engaged gearwheel 138 or 139 to the layshaft 124. Further movement of the sleeve 154 in the same direction causes stronger frictional force to bring a rotational speed of the sleeve 154 to be essentially the same rotational speed of the engaged gearwheel 138 or 139.

At this point, the engaged gearwheel 138 or 139 can be inter-locked smoothly with the layshaft 124 with no damage to the gearwheel 138 or 139. The dog rings 160 and 162 rotate at the same speed as the layshaft shaft 124 and the gearwheel 138 or 139. The corresponding dog ring 160 or 162 then slides towards the gearwheel 138 or 139 and it interlocks the selected gearwheels 138 or 139 to the layshaft shaft 124. The dog ring 160 or 162 is prevented from grinding or clashing with the gearwheel 138 or 139 because of the synchronization.

After the interlocking, the sleeve 154 is moved away from the interlocked gearwheel 138 or 139. This also causes the insert key 152 to follow the movement of the sleeve 154, which in turn urges the corresponding block ring 158 or 159 to move in the same direction. This arrangement prevents the corresponding block ring 158 or 159 from dragging against the cone portion. Wear of the block rings 158 and 159 is reduced.

When in use, the second idler gearwheel 138 and the layshaft 124 normally rotate at varying speeds. To achieve the synchronization, a gearshift lever pushes the sleeve 154 towards the second idler gearwheel 138. The sleeve 154 in turn moves the insert key 152 and the synchronizer hub 156 towards the second idler gearwheel 138. As a result, the block ring 158 is pushed by the insert key 152 and contacts the dog ring 160. Friction contact between the block ring 158 and the dog ring 160 then cause these two parts to rotate at the same speed. Since the dog ring 160 is attached to the second idler gearwheel 138, the second idler gearwheel 138 is brought to the same rotation speed as the synchronizer hub 156 because of the friction contact between the block ring 158 and the dog ring 160. Thus, the second idler gearwheel 138 is synchronized with the layshaft 124.

The second coupling device 146 later further locks the layshaft 124 to the second idler gearwheel 138. The locking happens when the lever pushes the sleeve 154 further towards the second idler gearwheel 138. Movement of the sleeve 154 causes the spline of the sleeve 154 engages the dog ring 160, which locks the second idler gearwheel 138 to the layshaft 124. Consequently, the second coupling device 146 and the second idler gearwheel 138 are connected together and spin at the same speed. The second coupling device 146 and the second idler gearwheel 138 can be later disengaged when the lever moves the sleeve 154 away from the second idler gearwheel 138.

When using the double clutch transmission 120 in a vehicle, the vehicle normally starts when the double clutch transmission 120 is at a Neutral state, which is often actuated by a gear lever in the vehicle. In the Neutral state, the dry outer clutch 48 is in a closed position by default, which causes driving torque from the crankshaft 66 of the engine to be transmitted via the outer input shaft 36, and via the second fixed gearwheel 126, to the second idler gearwheel 138. The second coupling device 146 is not connected the second idler gearwheel 138 to the layshaft 124. The second idler gearwheel 138 is turning whilst the pinion 140 remains stationary.

The vehicle can drive off with the first gear by shifting the gear lever to a Drive position. In the Drive position, the first coupling device 144 is moved to the left to engage the first idler gearwheel 136 to the layshaft 124. This is possible because the dry inner clutch 46 is disengaged from the inner input shaft 34 in the default position, which allows the first idler gearwheel 136 to be stationary for the engagement. By connecting the first coupling device 144 and the first idler gearwheel, the first gear is preselected in the Drive position. The second coupling device 146 is also stationary at this moment because the layshaft 124 has not been driven by the first idler gearwheel 136 yet. Upon releasing the vehicle brake, the dry double clutch 50 is activated such that the dry inner clutch 46 connects the crankshaft 66 to the inner input shaft 34. This causes the first fixed gearwheel 128 to start turning and it transmits the driving torque to the first idler gearwheel 136, to the first coupling device 144, to the layshaft 124, to the pinion 140 and further to the output gearwheel. At the same time, the dry outer clutch 48 has disconnected the outer input shaft 36 from the crankshaft 66. The vehicle drives off with its first gear.

Typically, the gearbox 122 can further be automatically shifted to a second gear with five seconds of driving at the first gear. However, since the second coupling device 146 follows the rotation of the layshaft 124 at the first gear and the second idler gearwheel 138 is freewheeling, the second coupling device 146 and the second idler gearwheel 138 are normally at different speeds. In order to transfer to the second gear, the second coupling device 146 has to synchronize and lock the second idler gearwheel 138 to the layshaft 124. For synchronizing the second idler gearwheel 138 with the second coupling device 146, referring also to FIG. 6, the sleeve 154 shifts to the left which forces the dog ring 160 to ride onto the second idler gearwheel 146 via the block ring 158. As the dog ring 160 experiences increasing pushing force from the sleeve 154, the second coupling device 146 synchronizes with the second coupling device 138 via the friction contact between the dog ring 160 and the block ring 158. As the sleeve 154 move further towards the second coupling device 138, the spline of the sleeve 154 engages the dog ring 160 such that the second coupling device 146 and the second idler gearwheel 138 are interlocked to each other. The interlocking of the second coupling device 146 and the second idler gearwheel 138 provides reselection of the second gear.

To drive the vehicle at the second gear, the dry double clutch 50 is then deactivated such that the dry inner clutch 46 disconnects the inner input shaft 34, and the dry outer clutch 48 joins back to the outer input shaft 36 at the same time. The driving torque is then transmitted from the crankshaft 66, via the dry outer clutch 46, via the outer input shaft 36, via the second fixed gearwheel 126, via the second idler gearwheel 138, via the second coupling device 146, and via the layshaft 124, to the pinion 140. The vehicle thus moves with the second gear. When the vehicle cruises at the second gear, the first coupling device 144 remains coupled to the first idler gearwheel 136, which causes both the first fixed gearwheel 128 and the inner input shaft 34 spinning.

When the vehicle stops, the dry double clutch 50 is again activated such that the dry outer clutch 48 disconnects the outer input shaft 36 from the crankshaft 66 and the dry inner clutch 46 connects the inner input shaft 34 to the crankshaft 66. Since the first coupling device 144 is engaged to the first idler gearwheel 136, the layshaft 124 immediately receives the driving torque from the inner input shaft 34, via the first fixed gearwheel 128, and via the first idler gearwheel 136, and via the first coupling device 144. This provides an engine brake effect via the first gear. The vehicle can be brought to a halt when a brake of the vehicle acts on wheels of the vehicle.

The double clutch transmission 120 is electronically controlled such that it can automatically return to the Neutral state when the vehicle stops. The dry double clutch 50 is deactivated in the Neutral state such that the dry inner clutch disconnects from the inner input shaft 34 and the dry outer clutch 48 connects to the outer input shaft 36. As the second coupling device 146 disengages the layshaft 124 from the second idler gearwheel 138, the layshaft 124 does not receive driving torque from the crankshaft 66, via the dry outer clutch 48, via the second fixed gearwheel 126, via the second idler gearwheel 138 even though the engine is still running as the vehicle stops.

If parking is required, the lever is moved to Park position. Both the coupling devices 144, 146 move away from their respective idler gearwheels 136, 138 for decoupling. A park-lock gearwheel can be introduced on the layshaft 124 for providing the secure parking. With the park-lock gearwheel, a pawl can be shifted onto the park-lock gearwheel such that the pinion 140 is prevented from spinning, resulting in secure parking of the vehicle. The pinion 140 is coupled to a differential of the vehicle, which is not shown in FIG. 5.

More fixed and idler gearwheels can be introduced into the double clutch transmission 120 for providing other gear speeds. For example, a double clutch transmission with the dry double clutch 50 can provide seven gear speeds. In the double clutch transmission of seven gear speeds, gearwheels of odd gear speeds are driven by dry inner clutch 46 via the inner input shaft 34, whilst gearwheels of even gear speeds are driven by the dry outer clutch 48 via the outer input shaft 36. This arrangement is similar that of the double clutch transmission 120 in FIG. 5. The new double clutch transmission also provides pre-selection of gear speeds.

Since the dry inner clutch 46 is closed in the default position, the gearwheels of odd gear speeds can be preselected when any of the odd gear speeds is predicted for driving by an electronic engine control unit of the double clutch transmission. In contrast, the gearwheels of even gears can only be preselected when the dry double clutch 50 is in the activated position.

The double clutch transmission provides the pre-selection to skip-shifts of gear speeds as well, either even to odd, or odd to even. For example, when performing gear speed skip-shift from seventh to fourth gear, the fourth gear can be preselected when the vehicle is driving at the seventh gear. In contrast, the double clutch transmission avoids pre-selection to skip-shifts of gear speeds even to even, or odd to odd. Sequential gearshifts provide smoother speed transition of the double clutch transmission. For example, the double clutch transmission can reduces gear speeds from fifth, to fourth and then to third gear speed instead of jumping from fifth to third gear directly.

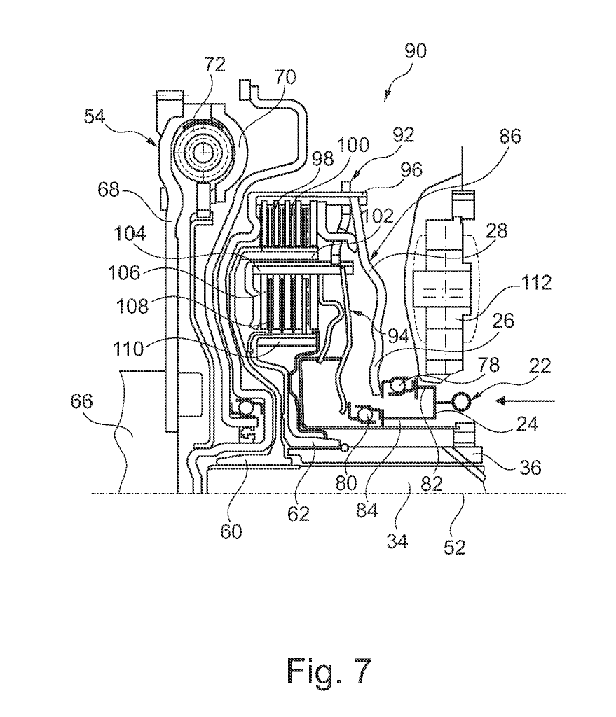

FIG. 7 illustrates a wet double clutch 90 according to the schematic diagram. FIG. 7 provides a second embodiment that comprises parts of same reference numbers. Relevant description of these parts is incorporated where appropriate. Certain parts of the wet double clutch 90 are not shown for simplicity and clarity of description.

The wet double clutch 90 comprises a wet inner clutch 92 and a wet outer clutch 94 that are detachable to a flywheel 54. The dual mass flywheel 54 is fixed onto a crankshaft 66 via the secondary flywheel 68 such that the crankshaft can drive the dual mass flywheel 54 around their common longitudinal axis 52. The wet inner clutch 92 is detachably coupled to an inner input shaft 34, whilst the wet outer clutch 94 is also detachably coupled to an outer input shaft 36.

The wet inner clutch 92 comprises an inner pressure plate carrier 96, an array of inner pressure plates 98, a stack of inner friction plates 100 and an inner friction plate carrier 102. The inner pressure plates 98 are parallel to each other and they are rooted onto the inner pressure plate carrier 96. An inner clutch lever 28 supports the inner pressure plate carrier 96 at its right end such that the inner pressure plates 98 can rotate around the longitudinal axis 52. Each of the inner friction plates 100 is inserted between neighboring inner pressure plates 98. Each of the inner pressure plates 98 and the inner friction plates 100 are adjacent to each other with gaps in-between. An inner friction plate carrier 102 holds the inner friction plates 100. Since the neighboring inner friction plates 100 and the inner pressure plates 98 are set apart from each other, the inner input shaft 34 is disengaged from the crankshaft 66 and the inner input shaft 34 can freely rotate around the longitudinal axis 52 in a default position of FIG. 7. FIG. 7 shows the wet double clutch 90 is in its deactivated state.

Conversely, the wet outer clutch 94 comprises an outer pressure plate carrier 104, an array of outer pressure plates 106, a stack of outer friction plates 108 and an outer friction plate carrier 110. The outer pressure plates 106 are parallel to each other and they are rooted at the outer pressure plate carrier 104. An outer clutch lever 28 supports the outer pressure plate carrier 104 at its right end. The neighboring outer pressure plates 106 and the outer friction plates 110 are inserted between each other with no gap in-between. Outer friction plate carrier 110 further holds the outer friction plates 108 such that the outer friction plates 108 cannot revolve around the longitudinal axis 52 because of friction contact between the outer pressure plates 106 and the outer friction plates 108. An outer splined hub 62 on the outer input shaft 36 supports the outer friction plate carrier 108. FIG. 7 shows the default position that the outer input shaft 36 is engaged to the wet outer clutch 94 when the wet double clutch 90 is deactivated.

The outer clutch lever 26 and the inner clutch lever 28 are supported by an outer clutch bearing 80 and an inner clutch bearing 78 respectively at their bottom ends. The inner clutch bearing 78 and the outer clutch bearing 80 are further supported by an inner branch 82 and an outer branch 84 respectively. Two opposite ends of a cross bar 24 are joined to the inner branch 82 and the outer branch 84. Similar to that of the dry dual clutch 50, an actuator 22 is connected to and the cross bar 24 such that the actuator 22 can push the inner branch 82 and the outer branch 84 towards left for activation.

A cooling pump 112 seats on a right side of the wet double clutch 90. The cooling pump 112 circulates cooling oil from a reservoir to the wet double clutch 90 such that the wet double clutch 90 is kept within its operating temperature when in use.

A restoring mechanism 86 of the wet double clutch 90 comprises the actuator 22, the inner branch 82, the outer branch 84, the inner clutch bearing 78, the outer clutch bearing 80, the outer clutch lever 26, the inner clutch lever 28, the inner pressure plate carrier 96, the inner pressure plates 98, the inner friction plates 100, the inner friction plate carrier 102, the outer pressure plate carrier 104, the outer pressure plates 106, the outer friction plates 108, the outer friction plate carrier 110, the inner splined hub 60 and the outer splined hub 62.

FIG. 7 also describes a default position of the wet double clutch 90. In the default position, the inner branch 82 and the outer branch 84 receive no force from the actuator 22 so that the bottom ends of the outer clutch lever 26 and the inner clutch lever 28 are at their right-most locations. Both the wet inner clutch 92 and the wet outer clutch 94 are held at the default position by resilience of the outer clutch lever 26 and the inner clutch lever 28.

The wet inner clutch 92 engages the inner input shaft 34 and the wet outer clutch 94 disengages the outer input shaft 36 in the default position. In detail, the inner pressure plates 98 are pushed onto the inner friction plates 100 for engaging the inner input shaft 34. In contrast, gaps exist between the outer pressure plates 106 and their neighboring outer friction plates 108. Consequently, the inner splined hub 60 locks the inner input shaft 34 such that the inner input shaft 34 receives driving torque from the crankshaft 66.

On the other hand, in an activated position, the actuator 22 advances towards left which causes both the inner clutch bearing 78 and the outer clutch bearing 80 to shift towards the left as well. The actuator 22 causes the outer clutch lever 26 and the inner clutch lever 28 to tilt which result in engaging the wet outer clutch 94 and releasing the wet inner clutch 92. When the wet outer clutch 94 is engaged, the outer pressure plates 106 and the outer friction plates 108 come so that the driving torque of the crankshaft 66 is transmitted to the outer splined hub 62 and further to the outer input shaft 36. The wet double clutch 90 locks either the inner input shaft 34 or the outer input shaft 36 to the crankshaft 66 for driving torque transmission by releasing or advancing the actuator 22.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims and their equivalents, rather than by the examples given. Moreover, while at least one exemplary embodiment has been presented in the foregoing detailed description, it should be appreciated that a vast number of variations exist. The foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A double clutch for connecting a crankshaft of an engine to one of a first input shaft and a second input shaft of a gearbox for engine torque transmission, comprising
a first clutch adapted to selectively connect the first input shaft of the gearbox to the crankshaft;
a second clutch adapted to selectively connect the second input shaft of the gearbox to the crankshaft; and
an actuator coupled to the first clutch and the second clutch, the actuator operable to move the first clutch and the second clutch between a default position and an activated position,
wherein in the default position, the first clutch connects the first input shaft to the crankshaft and the second clutch is adapted to disconnect the second input shaft from the crankshaft,
wherein in the activated position, the first clutch is adapted to disconnect the first input shaft from the crankshaft and the second clutch connects the second input shaft to the crankshaft, and
wherein the crankshaft is always connected to one of the first input shaft and the second input shaft.

2. The double clutch of claim 1, wherein the first clutch comprises an inner clutch adapted to connect an inner input shaft to the crankshaft, and the second clutch comprises an outer clutch adapted to connect an outer input shaft to the crankshaft.

3. The double clutch of claim 2 further comprising a dry double clutch that comprises an inner friction plate and an outer friction plate on opposite sides of a center plate along a longitudinal axis of the double clutch.

4. The double clutch of claim 1, wherein the first clutch comprises an inner splined hub on an inner input shaft that is adapted to engage the inner input shaft and the second clutch comprises an outer splined hub on an outer input shaft adapted to engage the outer input shaft.

5. The double clutch of claim 4, further comprising
a first clutch lever adapted to actuate the first clutch and a second clutch lever adapted to actuate the second clutch,
wherein the first clutch lever and the second clutch lever are mounted on a same side of the inner splined hub and the outer splined hub.

6. The double clutch of claim 5, wherein the actuator comprises a first branch adapted to actuate the first clutch lever via the first clutch bearing and a second branch adapted to actuate the second clutch lever via a second clutch bearing.

7. The double clutch of claim 1, further comprising, comprising a wet double clutch that comprises a wet first clutch and a wet second clutch.

8. The double clutch of claim 7, further comprising an inner splined hub on the first input shaft adapted to engage the first input shaft and an outer splined hub on the second input shaft adapted to engage the second input shaft, the inner splined hub and the outer splined hub being immediately adjacent to each other.

9. The double clutch of claim 1, further comprising a restoring mechanism adapted to restore the double clutch from the activated position to the default position if an external power supply is absent.

10. A double clutch transmission, comprising:
a double clutch adapted to connect a crankshaft of an engine to one of two input shafts of a gearbox for engine torque transmission, the double clutch comprising:
a first clutch adapted to selectively connect a first input shaft of the gearbox to the crankshaft;
a second clutch adapted to selectively connect a second input shaft of the gearbox to the crankshaft; and
an actuator coupled to the first clutch and the second clutch, the actuator operable to move the first clutch and the second clutch between a default position and an activated position,
wherein in the default position, the first clutch connects the first input shaft to the crankshaft and the second clutch is adapted to disconnect the second input shaft from the crankshaft,
wherein in the activated position, the first clutch is adapted to disconnect the first input shaft from the crankshaft and the second clutch connects the second input shaft to the crankshaft, and
wherein the crankshaft is always connected to one of the first input shaft and the second input shaft;
wherein the gearbox is connected to the double clutch, the gearbox comprising:
the first input shaft and the second input shaft adapted to selectively connect to the double clutch;
a layshaft; and
gearwheels mounted on the first input shaft, the second input shaft, and the layshaft, the gearwheels comprising:
a fixed gearwheel on the first input shaft and the second input shaft;
an idler gearwheel on the layshaft meshing with the fixed gearwheel;
a coupling device on the layshaft adapted to connecting the idler gearwheel to the layshaft; and
a pinion mounted on the layshaft.

11. The double clutch transmission of claim 10, further comprising gearwheels of different driving gears adapted to providing various output speeds of the double clutch transmission.

12. The double clutch transmission of claim 10, wherein the first clutch comprises an inner clutch adapted to connect an inner input shaft to the crankshaft, and the second clutch comprises an outer clutch adapted to connect an outer input shaft to the crankshaft.

13. The double clutch transmission of claim 12, further comprising a dry double clutch that comprises an inner friction plate and an outer friction plate on opposite sides of a center plate along a longitudinal axis of the double clutch.

14. The double clutch transmission of claim 10, wherein the first clutch comprises an inner splined hub on an inner input shaft that is adapted to engage the inner input shaft and the second clutch comprises an outer splined hub on an outer input shaft adapted to engage the outer input shaft.

15. The double clutch transmission of claim 14, further comprising a first clutch lever adapted to actuate the first clutch and a second clutch lever adapted to actuate the second clutch,
wherein the first clutch lever and the second clutch lever are mounted on a same side of the inner splined hub and the outer splined hub.

16. The double clutch transmission of claim 15, wherein the actuator comprises a first branch adapted to actuate the first clutch lever via the first clutch bearing and a second branch adapted to actuate the second clutch lever via a second clutch bearing.

17. The double clutch transmission of claim 10, further comprising, comprising a wet double clutch that comprises a wet first clutch and a wet second clutch.

18. The double clutch transmission of claim 17, further comprising an inner splined hub on the first input shaft adapted to engage the first input shaft and an outer splined hub on the second input shaft adapted to engage the second input shaft, the inner splined hub and the outer splined hub being immediately adjacent to each other.

19. The double clutch transmission of claim 10, further comprising a restoring mechanism adapted to restore the double clutch from the activated position to the default position if an external power supply is absent.

20. A powertrain, comprising:
an engine adapted to generate a driving torque;
a double clutch transmission connected between the engine for receiving the driving torque, the double clutch transmission comprising:
a double clutch adapted to connect a crankshaft of an engine to one of two input shafts of a gearbox for engine torque transmission, the double clutch comprising:
a first clutch adapted to selectively connect a first input shaft of the gearbox to the crankshaft;
a second clutch adapted to selectively connect a second input shaft of the gearbox to the crankshaft; and
an actuator coupled to the first clutch and the second clutch, the actuator operable to move the first clutch and the second clutch between a default position and an activated position,
wherein in the default position, the first clutch connects the first input shaft to the crankshaft and the second clutch is adapted to disconnect the second input shaft from the crankshaft,
wherein in the activated position, the first clutch is adapted to disconnect the first input shaft from the crankshaft and the second clutch connects the second input shaft to the crankshaft, and
wherein the crankshaft is always connected to one of the first input shaft and the second input shaft;
the gearbox connected to the double clutch, the gearbox comprising:
the first input shaft and the second input shaft adapted to selectively connect to the double clutch;
a layshaft; and
gearwheels mounted on the first input shaft, the second input shaft, and the layshaft, the gearwheels comprising:
a fixed gearwheel on the first input shaft and the second input shaft;
an idler gearwheel on the layshaft meshing with the fixed gearwheel;
a coupling device on the layshaft adapted to connecting the idler gearwheel to the layshaft; and
a pinion mounted on the layshaft; and
differentials adapted to transmit a received driving torque to a final drive.

21. A method for using a double clutch for all gear shift positions of a gearbox, the method comprising:
connecting a crankshaft to the gearbox via a first clutch while a second clutch is disconnected from the gearbox; and
connecting the crankshaft to the gearbox via the second clutch while the first clutch is disconnected from the gearbox.

22. The method of claim 14, wherein the method is used for shifting between a neutral gear shift position and another gear shift position.
